(19) United States
(12) Patent Application Publication
(10) Pub. No.: US 2004/0048610 A1
(43) Pub. Date: Mar. 11, 2004

(54) Method and system for matching subscriber states in network in which public land mobile network and wired/wireless private network are interworked

(76) Inventors: Soo Hwan Kim, Hwascong-si (KR); Doo-Yong Yang, Seoul (KR); Dong-Youl Lee, Suwon-shi (KR); Gul-June Lee, Yongin-shi (KR)

Correspondence Address: Robert E. Bushnell, Suite 300, 1522 K Street, N.W., Washington, DC, 20005, US

(21) Appl. No.: 10/657,261

(22) Filed: Sep. 9, 2003

Related U.S. Application Data
(63) Continuation-in-part of application No. 10/259,846, filed on Sep. 30, 2002.

(30) Foreign Application Priority Data
Sep. 28, 2001 (KR) 2001-60674
Sep. 11, 2002 (KR) 2002-55150

(51) Int. Cl. H04B 7/00

(52) U.S. Cl. 455/422.1; 455/515; 455/561

(57) ABSTRACT

A method for matching subscriber states in a network in which a public land mobile network and a wired/wireless private network and a method for performing a call processing operation to manage state information of ANs (Access Nodes) according to incoming call reception and outgoing call transmission in a private network when a high-speed wireless data system uses the public and private networks. Where data communication is performed between two ANs coupled to the private network, the state information of the two ANs is updated according to states of the ANs performing the data communication. Even though one of the two ANs makes a call setup request through the public network, the number of paging message transmissions can be reduced and an error such as a paging non-response can be prevented. As the state information of the ANs within the private network is transferred to the public network from a mobile communication system, in which the private and public networks are interworked, the public network can identify the states of subscribers of the private network located within a cell shared between the public and private networks, and thus a public/private mobile communication service can be quickly and smoothly provided.

### CROSS REFERENCE TO RELATED APPLICATION

This application is a continuation-in-part of U.S. application Ser. No. 10/259,846 filed in the U.S. Patent & Trademark Office on Sep. 30, 2002, U.S. application Ser. No. 10/259,846 being incorporated herein by reference. Also, this application makes reference to, incorporates the same herein, and claims priority and all benefits accruing under 35 U.S.C. §120 from the aforementioned U.S. application Ser. No. 10/259,846, filed on Sep. 30, 2002, entitled APPARATUS, METHOD AND SYSTEM FOR MATCHING SUBSCRIBER STATES IN NETWORK IN WHICH PUBLIC LAND MOBILE NETWORK AND WIRED/WIRELESS PRIVATE NETWORK ARE INTERWORKED. This application relates to a U.S. patent application Ser. No. 10/259,811, which was submitted to the U.S. Patent & Trademark Office on Sep. 30, 2002, entitled APPARATUS, METHOD AND SYSTEM FOR MATCHING SUBSCRIBER STATES IN NETWORK IN WHICH PUBLIC LAND MOBILE NETWORK AND WIRED/WIRELESS PRIVATE NETWORK ARE INTERWORKED, and claims all benefits accruing under 35 U.S.C. §119 from an application entitled APPARATUS, METHOD AND SYSTEM FOR MATCHING SUBSCRIBER STATES IN NETWORK IN WHICH PUBLIC LAND MOBILE NETWORK AND WIRED/WIRELESS PRIVATE NETWORK ARE INTERWORKED earlier filed in the Korean Industrial Property Office on Sep. 28, 2001 and there duly assigned Serial No. 2001-60674. Each of the above-cited applications is incorporated herein by reference in its entirety.

### CLAIM OF PRIORITY

This application makes reference to, incorporates the same herein, and claims all benefits accruing under 35 U.S.C. §119 from an application for APPARATUS, METHOD AND SYSTEM FOR MATCHING SUBSCRIBER STATES IN NETWORK IN WHICH PUBLIC LAND MOBILE. NETWORK AND WIRED/WIRELESS PRIVATE NETWORK ARE INTERWORKED earlier filed in the Korean Industrial Property Office on Sep. 28, 2001 and there duly assigned Serial No. 2001-60674 and for METHOD AND SYSTEM FOR MATCHING SUBSCRIBER STATES IN NETWORK IN WHICH PUBLIC LAND MOBILE NETWORK AND WIRED/WIRELESS PRIVATE NETWORK ARE INTER WORKED earlier filed in the Korean Industrial Property Office on Sep. 11, 2002 and there duly assigned Serial No. 2002-55150.

### BACKGROUND OF THE INVENTION

1. Field of the Invention

The present invention relates to a mobile communication system interworked with a PLMN (Public Land Mobile Network) and a wired/wireless private network, and more particularly to an apparatus, method and system for matching subscriber states of a PLMN and subscriber states of a wired/wireless private network by informing the PLMN of the subscriber states associated with the wired/wireless private network in a mobile communication system.

2. Description of the Related Art

It is difficult for the public and private networks to be interworked with each other because a public mobile communication network and a private (or local area) mobile communication network are individually implemented. In other words, a conventional mobile communication system can provide either public mobile communication services or private mobile communication services. A subscriber of a mobile communication terminal registered in the public network cannot use the private mobile communication services. Similarly, a subscriber of a mobile communication terminal registered in the private network cannot use the public mobile communication services. Accordingly, a system, which can provide the subscriber of one mobile communication terminal with both the public and private mobile communication services, is seriously needed.

Copending Korean Patent Application Ser. No. 200-028172 entitled “SYSTEM AND METHOD FOR PROVIDING PUBLIC/PRIVATE MOBILE COMMUNICATION SERVICE”, filed in the Korean Industrial Property Office on May 24, 2000 by Samsung Electronics Co., Ltd. is disclosed as an example of a public and private mobile communication system, which can provide one mobile communication terminal with both public and private mobile communication services.

Hereinafter, an MS is a mobile station being a mobile communication terminal. An MSC, a BSC and a BTS denote a mobile switching center, a base station controller and a base station transceiver subsystem, respectively. A prefix “p” attached to “MS”, “MSC”, “BSC” or “BTS” means “private”. For convenience, the prefix “p” is used to distinguish components of the private network from components of the public network.

Copending Korean Patent Application Ser. No. 2000-06083 entitled “APPARATUS AND METHOD FOR PERFORMING PACKET DATA COMMUNICATION IN LOCAL-AREA RADIO INTERNET”, filed in the Korean Industrial Property Office on Sep. 28, 2000 by Samsung Electronics Co., Ltd. is disclosed as an example of enabling use of a local-area radio internet by applying a wired/wireless mobile communication system to a 3G (3^{rd} generation) network.

As disclosed in Korean Patent Application Ser. No. 2000-060831, a paging signal is transmitted through a path of“MSC→BSC→BTS→MS” in a conventional PLMN rather than an interworking service system in which the public and private networks are interworked, and a paging response message generated by the MS is transmitted through a path of “MS→BTS→BSC→MSC” as a reverse path of the paging signal path.

On the other hand, a wired/wireless communication service system disclosed in Korean Patent Application Ser. No. 2000-060831 transmits a paging signal through a path of “MSC→BSC→pBSC→BTS→MS” and a paging response message generated by the MS for the public and private networks is transmitted through a path of “MS→BTS→pBSC→BSC→MSC” as a reverse path of the paging signal path. Here, the pBSC transparently transmits the paging signal where it is the public-network paging signal and therefore does not affect processing of incoming and outgoing paging signals from and to the public network in a terminal, which is located within a public and private cell area. Accordingly, the private network is compatible with the public network. Further, the BSC for the public network can be directly coupled to the BTS without the use of the pBSC. Where the paging signal from the private network is generated, the processing of the paging signal is controlled within the private network.

When a local-area MS located within the public and private cell area, communicates with another local-area terminal or another terminal through a PBX (another local-area terminal coupled to the PBX or another terminal coupled to a PSTN (Public Switched Telephone Network), which can be coupled to an office line of the PBX) in the wired/wireless mobile communication system, the public network generates a paging signal because the public network recognizes the fact that the corresponding terminal is in an idle state rather than the fact that the corresponding terminal is coupled to a local-area call, where the public network pages the local-area MS. However, when the terminal is coupled to the local-area call, it cannot give any response to the paging signal from the public network. Accordingly, the public network does not identify a current location of a corresponding MS and transmits a second paging signal. There is a problem in that this causes radio resources of the public network to be wasted and cannot enable a caller to exactly recognize a state of a called party. Here, the second paging signal means not only an increase of the number of paging times but also expansion of a paging zone. In other words, the number of BTSs within the paging zone when the second paging signal is transmitted can be increased more than that within the paging zone when a first paging signal is transmitted. Here, the paging zone is previously prescribed. Further, the paging performed in the public network can exceed a predetermined paging range corresponding to the public and private networks.

Although arbitrary ANs (Access Nodes) vary between an idle state and a busy state after the ANs coupled to a wireless private network perform data communication in a high-speed wireless data system such as 1× EV-DO (1× Evolution-Data Only), the public network does not identify the variation in the states of the ANs and determines only that the ANs are still in the idle state. In this state, if a call connection request for the arbitrary ANs is generated from the public network, the public network transmits a paging message to an ANTS (Access Network Transceiver System) because the public network determines that the arbitrary ANs are in the idle state, and the ANTS performs a paging non-response process. Such a paging non-response process causes an error in a call processing procedure and a paging message transmission process. These unnecessary processes can increase a load of the public network.

### SUMMARY OF THE INVENTION

Therefore, the present invention has been made in view of the above and other problems, and it is an object of the present invention to provide a method for providing a public network with state information of ANs (Access Nodes) according to incoming call reception and outgoing call transmission in a wireless private network.

It is another object of the present invention to provide an apparatus, method and system for matching subscriber state information of a private network and subscriber state information of a public network by transmitting state information of terminals located within the private network to the public network in a mobile communication system interworked with the public and private networks.

It is another object to provide a method and system when the communication is performed between access nodes within a wireless private network, the system updates the subscriber information according to the state of the access nodes.

In accordance with a first aspect of the present invention, the above and other objects can be accomplished by the provision of a method for performing a call processing operation to manage state information of ANs (Access Nodes) in a high-speed wireless data system, including the steps of: when an AN coupled to a wireless private network makes a request for a call connection with another AN coupled to the wireless private network, carrying out a call connection between the ANs, providing a high-speed wireless data service for the ANs, and carrying out a call connection release after completing the high-speed wireless data service; and updating state information of the ANs according to the call connection and connection release between the ANs.

In accordance with a second aspect of the present invention, there is provided a method for performing a call processing operation to manage state information of ANs (Access Nodes) in a high-speed wireless data system, including the steps of: when an AN coupled to a wireless private network makes a request for a call connection with another AN coupled to the wireless private network, carrying out a call connection between the ANs and providing a high-speed wireless data service for the ANs; updating state information of the ANs to busy state information; when the high-speed wireless data service for the ANs is completed, carrying out a call connection release; and updating the state information of the ANs to idle state information according to the call connection release.

In accordance with a third aspect of the present invention, there is provided a method for performing a call processing operation to manage state information of ANs (Access Nodes) in a high-speed wireless data system, including the steps of: when an AN coupled to a wireless private network makes a request for a call connection with another AN coupled to the wireless private network, allowing a pANC (private Access Network Controller) to carry out a call connection between the ANs and to provide a high-speed wireless data service for the ANs; allowing the pANC to request that state information of the ANs be updated; allowing a DLR (Data Location Register) to update the state information of the ANs to busy state information according to a state information update request; when the high-speed wireless data service for the ANs is completed, carrying out a call connection release between the ANs and allowing the pANC to request that the state information of the ANs be updated; and allowing the DLR to update the state information of the ANs to idle state information according to another state information update request.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view illustrating a configuration and its communication path associated with a public and private mobile communication system in which the present invention can be applied;

FIG. 2 is an exemplary view illustrating a configuration of a public and private communication service apparatus associated with a public and private mobile communication system in which the present invention can be applied;

FIG. 3 is another exemplary view illustrating a configuration of a public and private communication service apparatus associated with a public and private mobile communication system in which the present invention can be applied;

FIG. 4 is a flow chart illustrating a method for processing a paging call signal from a public network in a public and private communication service apparatus associated with a public and private mobile communication system in which the present invention can be applied;

FIG. 5 is another exemplary view illustrating a configuration of a public and private communication service apparatus associated with a public and private mobile communication system in accordance with the present invention;

FIG. 6 is a view illustrating a structure of a table having state information of MSs (Mobile Stations) included in a visitor location register for a private network in accordance with the present invention;

FIG. 7 is a view illustrating a format of a paging response message in accordance with the present invention;

FIG. 8 is a flow chart illustrating a method for allowing a private network to process a paging call signal from a public network in accordance with the present invention;

FIG. 9 is a flow chart illustrating a method for allowing a private network to transmit state information of a local-area MS located within a public and private cell area to the public network in accordance with the present invention;

FIG. 10 is a flow chart illustrating a method for transmitting an MS state message to an MSC (Mobile Switching Center) when the private network terminates an MS call in accordance with the present invention;

FIG. 11 is a view illustrating a format of a new message, which is made for matching subscriber states, in accordance with the present invention;

FIG. 12 is a view illustrating a message in which sub-ID and sub-type data are added to a pre-existing message for matching subscriber states in accordance with the present invention;

FIG. 13 is a view illustrating a message in which sub-ID and sub-type data are added to a location registration message for matching subscriber states in accordance with the present invention;

FIG. 14 is a view illustrating a configuration of a public/private mobile communication network where the present invention is applied to a high-speed wireless data system for 1× EV-DO (1× Evolution-Data Only) ANs (Access Nodes);

FIG. 15 is a flow chart illustrating a call processing procedure for managing state information of ANs shown in FIG. 14; and

FIG. 16 shows an example of a computer including a computer-readable medium having computer-executable instructions for performing a method of the present invention.

### DETAILED DESCRIPTION OF THE PREFERRED EMBODIMENTS

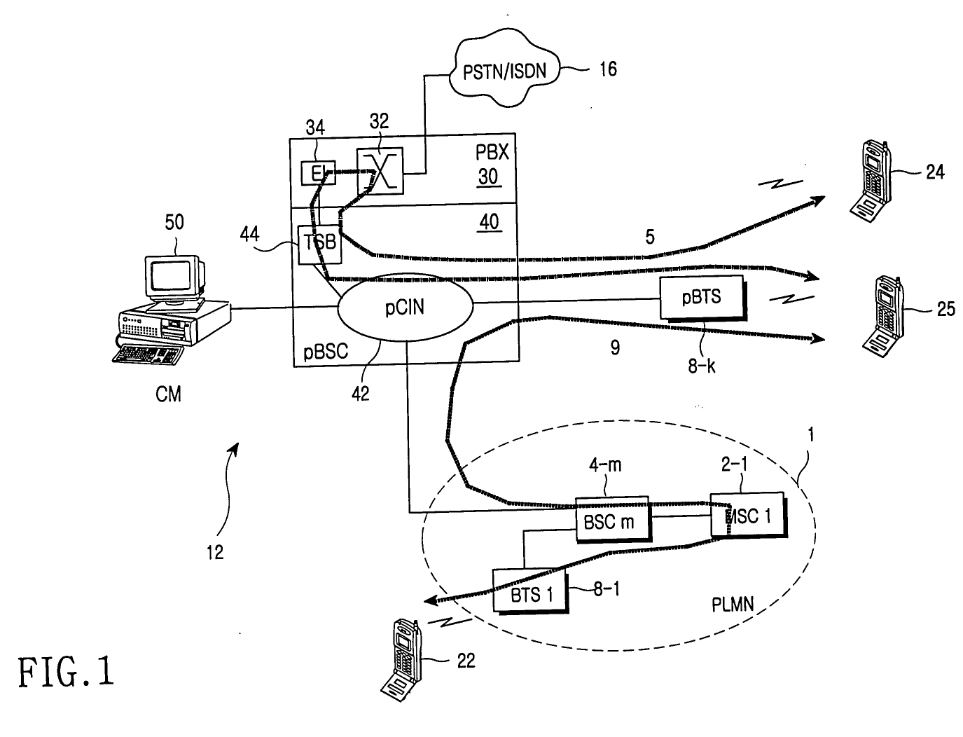

A schematic configuration and a communication path of a system shown in FIG. 1 will be described. FIG. 1 has certain features related to the disclosure in Korean Patent Application Ser. No. 2000-028172.

Referring to FIG. 1, a public and private communication service apparatus 12 is made up of a PBX (Private Branched eXchange) 30, a pBSC (private BSC) 40 and a CM (Call Manager) 50. The PBX 30 includes a switch 32 and an E1 (European subscriber line) interface 34, and the pBSC 40 includes a pCIN (private Communication Interconnection Network) 42 and a TSB (Transcoder & Selector Bank) 44.

It should be understood that only internal configurations of the PBX 30 and the pBSC 40 as components necessary for explaining a communication path when the public and private mobile communication services are provided are shown in FIG. 1 and other components are omitted in FIG. 1. It is assumed that MSs 24 and 25 are registered in the public and private communication service apparatus 12 so that the MSs 24 and 25 are located within a public and private cell area and can use the private mobile communication services. Further, it is assumed that an MS 22 is located within a public cell area. Under these assumptions, a communication path (that is, a traffic channel) 5 made up of the MS 24, a pBTS 8-k, the pCIN 42 of the pBSC 40, the TSB 44, an E1 interface 34, the switch 32, the TSB 44, the pCIN 42, the pBTS 8-k and the MS 25, and a reverse communication path of the communication path 5 are examples of the case where the private mobile communication services are provided. Further, a communication path (that is, a traffic channel) 9 made up of the MS 25, the pBTS 8-k, the pCIN 42 of the pBSC 40, a BSC 4-m of a PLMN 1, an MSC 2-1, the BSC 4-m, the BTS 8-1 and the MS 22, and a reverse communication path of the communication path 9 are examples of the case where the public mobile communication services are provided. The CM 50 being a main controller of the public and private communication service apparatus 12 controls the formation of the communication paths for the mobile communication services. The public and private communication service apparatus 12 provides wired communication services, IP (Internet Protocol) terminal communication services and the public and private mobile communication services. The PBX 30 supports the wired communication services and a gatekeeper (not shown) based on a VoIP (Voice over Internet Protocol) supports the IP terminal communication services. The CM 50 controls the public and private mobile communication services, that is, radio call services.

Now, preferred embodiments of the present invention will be described in detail with reference to the annexed drawings. In the drawings, the same or similar elements are denoted by the same reference numerals even though they are depicted in different drawings. In the following description made in conjunction with preferred embodiments of the present invention, a variety of specific elements such as concrete circuits are shown. The description of such elements has been made only for a better understanding of the present invention. Those skilled in the art will appreciate that the present invention can be implemented without using the above-mentioned specific elements. Also, in the following description, a detailed description of known functions and configurations incorporated herein will be omitted when it may make the subject matter of the present invention rather unclear.

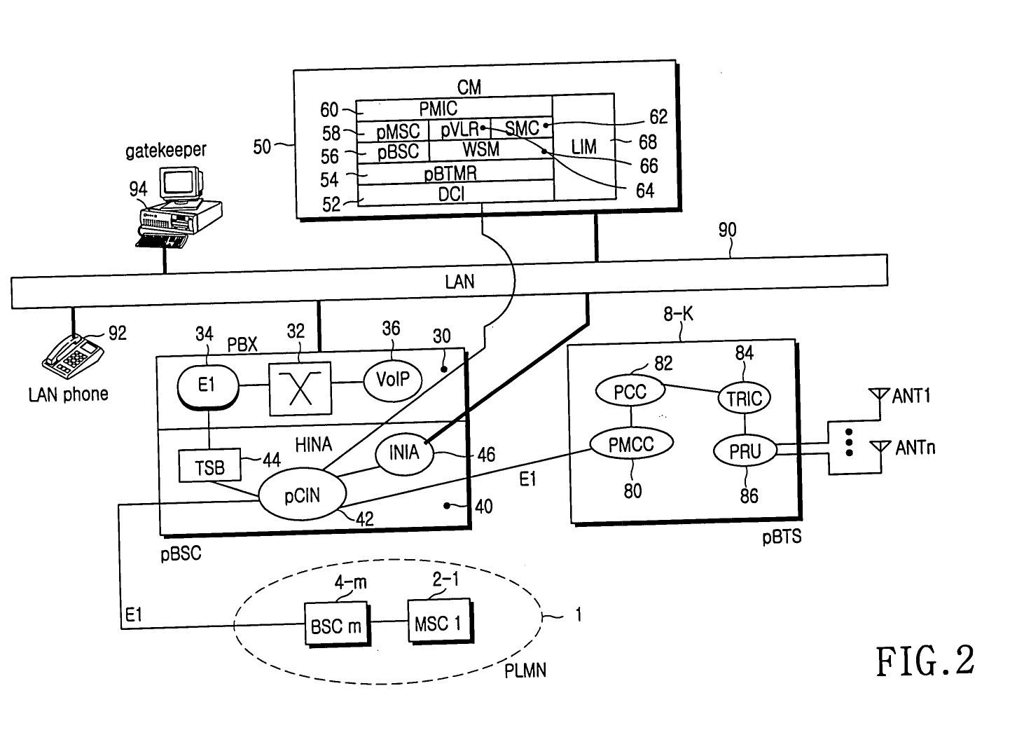

FIG. 2 is an exemplary view illustrating a configuration of a public and private communication service apparatus associated with a public and private mobile communication system in which the present invention can be applied.

In accordance with an embodiment of the present invention, the public and private communication service apparatus 12 shown in FIG. 1 provides wired communication services, IP (Internet protocol) terminal communication services and public and private mobile communication services. As shown in FIG. 2, a PBX 30 supports the wired communication services and a gatekeeper 94 supports the IP terminal communication services. A CM 50 controls the public and private mobile communication services, that is, radio call services.

The PBX 30, an INIA (IP Network Interface board Assembly module) 46 included in a pBSC 40 and an LIM (LAN Interface Module) 68 included in the CM 50 are coupled to a LAN 90. The gatekeeper 94 is further coupled to the LAN 90. IP terminals such as a LAN-phone 92, a web-phone and a PC (Personal Computer) are coupled to the LAN 90.

The pBSC 40 performs a radio link control function, a hand off function, etc. corresponding to a BSC included in a public mobile communication system. A main controller of the pBSC 40 can be embedded as a software module in the CM 50. The pBSC 40 includes a pCIN 42. The pCIN 42 provides communication paths coupled to the CM 50, a BSC 4-m included in a PLMN 1 and a pBTS 8-k, and a data path among components included in the pBSC 40. In other words, the pCIN 42 analyzes a message type, a caller address and a destination address contained in a received message and then transmits a result of the analysis to a corresponding device or processor. An E1 line is coupled between the pCIN 42 and the BSC 4-m of the PLMN 1 and between the pCIN 42 and the pBTS 8-k. A TSB 44 coupled to the pCIN 42 of the pBSC 40 is used to provide a mobile communication subscriber for the private network with wireless communication services. The TSB 44 performs a function of matching communication data between the PBX 30 and the pBSC 40. The INIA 46 coupled to the pCIN 42 of the pBSC 40 supports local-area radio data services. The INIA 46 transmits a data packet to the LAN 90 using a PPP (Point to Point Protocol) server and a TCP (Transmission Control Protocol/Internet Protocol)/IP, wherein the data packet is received from an MS located within a public and private cell area.

A VoIP module 36 located within the PBX 30 is coupled between a switch 32 included in the PBX 30 and the LAN 90. The VoIP module 36 provides VoIP services where the IP terminal such as the LAN-phone 92 or etc. and a wired terminal (not shown) coupled to the PBX 30 are interworked by the switch 32.

The CM 50 coupled to the pBSC 40 and the LAN 90 performs a function of controlling a radio call for public and private mobile communication services. At this time, call services for the MS in the public network performs a control function so that a message can be bypassed to the MSC for the public network. The CM 50 performs a function of administrating and maintaining radio resources. However, an MSCl 2-1 for the public network performs resource management for the pBTS 8-k and the CM 50 only refers to the resource management performed by the MSCl 2-1. The CM 50 performs a function of loading a program in a processor for controlling pBSC resources and a PLD (Program Loaded Data). However, the loading for the pBTS 8-k is performed by a BSM (Base Station Manager) (not shown). The CM 50 controls a wired and wireless composite function. Further, the CM 50 supports a radio SMS (Short Message Service) for the local area. Furthermore, the CM 50 supports a function of registering a subscriber in a private mobile communication network and setting functions, and performs a function of managing a VLR (Visitor Location Register) for use in roaming of the MS registered in the private mobile communication network.

In order to perform these functions, the CM 50 has software modules including a DCI (Data Communication Interface) 52, a pBTMR (pBTS Message Router) 54, a pBSC (private BSC) 56, a pMSC (private Mobile Switching Center) 58, a PMIC (PBX Mobile Interface Controller) 60, an SMC (Short Message service Controller) 62, a pVLR (private VLR) 64, a WSM (Wireless System Manager) 66 and an LIM (LAN Interface Module) 68. The DCI 52 is an interface module for supporting communication between the pCIN 42 of the pBSC 40 and the CM 50. The DCI 52 supports IPC (Inter Processor Communication) through an HINA (High speed IPC Node board Assembly). The pBTMR 54 designates a path for all messages to be processed in the pBTS 8-k. In more detail, the pBTMR 54 retrieves an internal router table, designates a control (signal) message path for providing the MS with incoming and outgoing call services (for the public and private networks) and designates a message path for maintenance services of the pBTS 8-k. Further, the pBTMR 54 communicates with the pVLR 64. The pBSC 56 as the main controller of the pBSC 40 controls the pBTS 8-k. When the pMSC 58 supports the public and private mobile communication services, it is located between the pBSC 56 and the PMIC 60 and performs a function similar to a function of the MSC included in a pre-existing public mobile communication network. Further, in accordance with the embodiment of the present invention, the pMSC 58 basically processes a subscriber call, analyzes other supplementary services and processes an interface with the PBX 30. In more detail, the pMSC 58 analyzes a service request from the subscriber, determines whether either service for a pre-existing public mobile communication network or service for the private mobile communication network must be provided in response to the service request, and processes a corresponding procedure based on a result of the determination. An interface with the pBSC 56 is based on a procedure in the public mobile communication network and uses an internal IPC. The PMIC 60 controls the wired and wireless composite function. The PMIC 60 is located within the public and private cell area. The PMIC 60 controls a call between MSs, e.g., the MSs 24 and 25 shown in FIG. 1, and a wired terminal coupled to the PBX 30. The pMSC 58 is different from a pre-existing MSC for the public network in that the pMSC 58 cannot directly perform a switching function. The pMSC 58 as the software module does not include a switch. Thus, when the private mobile communication services are provided, the public and private communication service apparatus 12 uses the switch 32 of the PBX 30. In accordance with the embodiment of the present invention, the PMIC 60 generates an instruction necessary for controlling the switch 32 of the PBX 30 in response to a switch control request from the pMSC 58 and transmits the instruction to a controller (not shown) included in the PBX 30. The controller of PBX 30 performs the switching function in response to the instruction. The SMC 62 controls the SMS and acts as an SMS web server. The pVLR 64 manages subscriber information registered in the private mobile communication services, location registration information of a mobile communication subscriber for the private network and other supplementary service information. The WSM 66 performs all the administration and maintenance functions of the mobile communication services provided by the public and private communication service apparatus 12. The WSM 66 is coupled to an operator console (not shown) for interface with an operator. The LIM 68 is a software module for communicating with the LAN 90. The LIM 68 uses an OS (Operating System) to perform a communication function through the PMIC 60, the SMC 62, the pVLR 64, the WSM 66 and the LAN 90.

The pBTS 8-k includes a PMCC (pBTS Main Controller Card) 80, a PCC (pBTS Channel Card) 82, a TRIC (Transmit & Receive Interface Card) 84 and a PRU (private BTS Radio Unit) 86. Since components included in the pBTS 8-k and their functions are similar to those included in the BTS of a conventional public mobile communication system and their functions, a detailed description of the pBTS 8-k will be omitted in this specification. The PMCC 80 performs an overall control of the pBTS 8-k, processes a signaling message relating to call set-up and system performance, manages hardware and software, and performs resource assignment. The PCC 82 processes base-band signals on the basis of a radio communication standard. The TRIC 84 performs transmission and reception interface between the PRU 86 and the PCC 82. The PRU 86 is an RF (Radio Frequency) module. The PRU 86 is coupled to a plurality of antennas ANTl-ANTn.

The public and private communication service apparatus 12 provides the wired services, the IP terminal services and the public and private mobile communication services. Hereinafter, a detailed description will be given of the public and private mobile communication services performed by the public and private communication service apparatus 12.

The public and private communication service apparatus 12 provides the MSs registered in the CM 50 with wired and wireless composite function services as well as wireless communication services. The wireless communication services include outgoing call transmission services, incoming call reception services, call transfer service, call forwarding services, local-area radio data services and local-area radio SMS services. The wired and wireless composite function services include a service for simultaneously informing the wired terminal and a corresponding MS of an incoming call when the communication service apparatus 12 receives the call incoming into the wired terminal.

The term public and private mobile communication system means that it can provide public and private mobile communication services. Accordingly, all the messages incoming into the communication service apparatus 12 are analyzed and a control (signal) message corresponding to the public mobile communication network is transmitted to the BSC for the public network and a control (signal) message corresponding to the private mobile communication network is routed to the modules within the CM 50. The pBTMR 54 included in the CM 50 performs a routing function. Where an outgoing call transmission event, an incoming call reception event, a location registration event or an SMS service event occurs, the pBTMR 54 analyzes a message corresponding to the event and designates a routing path associated with the message. The pBTMR 54 is equipped with a router table, which has routing information mapped to each event. The message is transmitted to a corresponding device and module using the router table.

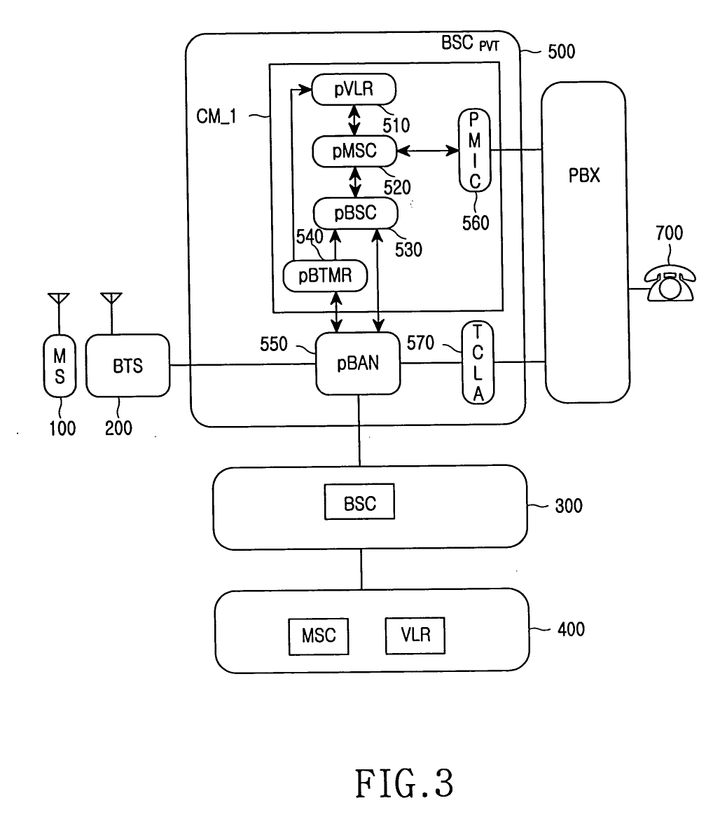

FIG. 3 is another exemplary view illustrating a configuration of a public and private communication service apparatus associated with a public and private mobile communication system in which the present invention can be applied.

As shown in FIG. 3, the public and private communication service apparatus is made up of a BTS 200, a BSC_{PVT} 500 (where “PVT” stands for “private”), and an ATM (Asynchronous Transfer Mode) network arranged between wireless public networks 300 and 400. The public and private communication service apparatus transmits a signal packet, a voice compression packet and a data packet.

The CM 50 acts as an independent server in FIG. 2. However, a card instead of the independent server as the CM 50 is embedded in the BSC_{PVT} 500 in FIG. 3. Referring to FIG. 3, the card of the CM 50 denotes “CM_{—}1”. The card CM_{—}1 has software modules including a pVLR 510, a pMSC 520, a pBSC 530, a pBTMR 540 and a PMIC 560. The BSC_{PVT} 500 includes a pBAN (private BSC ATM Network) 550, a TCLA (Transcode Control and Link Board Assembly) 570, etc. coupled to a packet message path.

An MS 100 located in a local area (private) network can receive and transmit call signals from and to the wireless public networks 300 and 400 through the BTS 200. The VLR in the wireless public network continuously updates a state of the MS 100 to a busy state or an idle state. If a call signal is transmitted to an MSC included in the wireless public network 400 from another MSC, an HLR (Home Location Register) (not shown) queries a subscriber state from the VLR. At this time, if the subscriber state is the idle state, the call signal is routed from another MSC to the MSC included in the wireless public network 400 so that paging is performed.

A description will be given of a communication path in the case where the call signal incoming into the public network is received. The MSC included in the wireless public network 400 transmits a paging request message to a BSC 300 through ITU-T (telecommunication standardization sector of the International Telecommunication Union) signaling system No. 7. In response to the paging request message, the BSC 300 transmits a general paging message to the BTS 200 through the pBSC 530. The BTS 200 receives the paging message through a paging channel. However, when an incoming call is generated, the state of the MS 100 recorded in the VLR is queried. The MSC included in the wireless public network 400 determines whether the MS 100 is in the busy state. If the MS 100 is in the busy state, the MSC 400 performs a process corresponding to the busy state.

Hereinafter, a description will be given of a communication path in the case where a local-area call is generated.

Where an incoming call is generated, the PBX 600 transmits a paging request message to the pBSC 530. In response to the paging request message, the pBSC 530 transmits a paging message to the BTS 200. In response to the paging message, the BTS 200 performs paging through the paging channel.

On the other hand, where an outgoing call is generated, the MS 100 transmits an outgoing call message to the pBSC 530 through the BTS 200. In response to the outgoing call message, the pMSC 520 occupies an available channel of E1 channels coupled between the pBSC 530 and the PBX 600. Thereafter, the pMSC 520 transmits an assignment request message to the pBSC 530. In response to the assignment request message, the pBSC 530 transmits a channel assignment message to the BTS 200. Accordingly, a link set-up is made between a vocoder (not shown) of the pBSC 530 and a channel of the BTS 200. Thereafter, the MS 100 transmits a service connection completion message to the pBSC 530. In response to the service connection completion message, the pBSC 530 informs the pMSC 520 that the link set-up has been completed through the transmission of the assignment completion message. In response to the assignment completion message, the pMSC 520 transmits a call message to the PBX 600 so that the PBX 600 can route the call message to a called party.

The paging request message is transmitted from the BSC 300 to the BTS 200 through the pBSC 530. At this time, the pBSC 530 analyzes destination information contained in the paging request message. If the destination information corresponds to a subscriber located within the local area, it is determined whether the subscriber is in a local-area call connection or busy state. If the subscriber is in the call connection or busy state, the paging request message can be rejected.

Up to now, the description of a public and private communication service apparatus associated with a public and private mobile communication system in which the present invention can be applied has been provided only for a better understanding of the present invention. Those skilled in the art will appreciate that the present invention can be applied in another system and device having components and communication paths similar to the above-described embodiments.

Hereinafter, a detailed description will be given of the present invention based on the public and private communication service apparatus shown in FIGS. 2 or 3. However, the preferred embodiments of the present invention have been disclosed for illustrative purposes, they are not intended to limit the scope of the present invention. Those skilled in the art will appreciate that the present invention can be applied in another system and device having components and communication paths similar to the above-described embodiments shown in FIGS. 2 or 3.

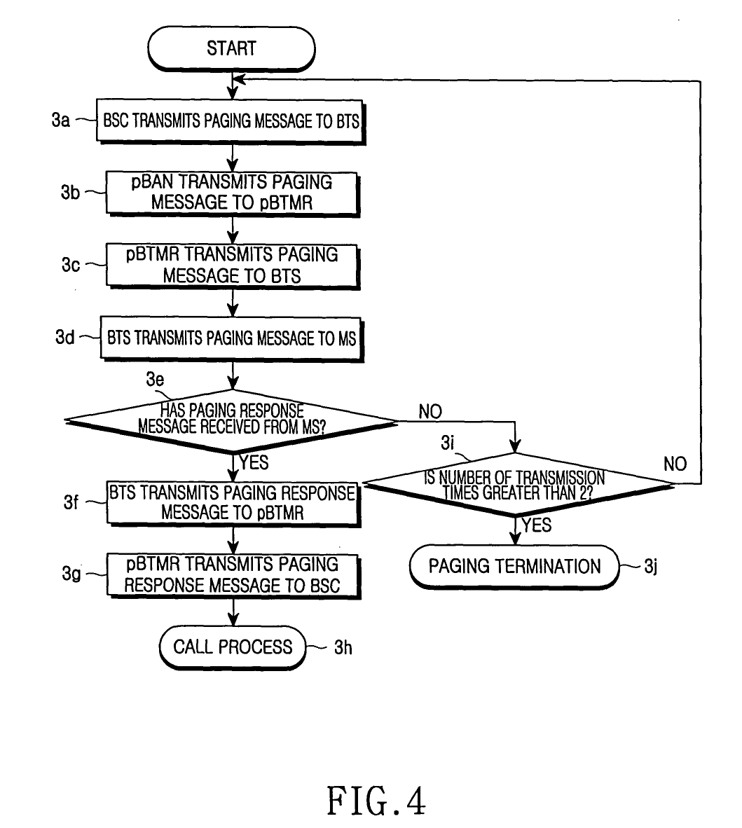

FIG. 4 is a flow chart illustrating a method for processing a paging call signal from a public network in a public and private communication service apparatus associated with a public and private mobile communication system shown in FIGS. 2 or 3. Hereinafter, the method will be described with reference to FIGS. 3 and 4.

The BSC 300 transmits a paging message to the BTS 200 in order to page the MS 100 located in a cell area for the public and private networks at step 3a. Then, the pBAN 550 transmits the paging message to the pBTMR 540 at step 3b. In FIG. 2, the paging message is transmitted to the pBTMR 540 through the pCIN 42. Returning to FIG. 3, the pBTMR 540 transmits the paging message to the BTS 200 at step 3c.

The BTS 200 transmits the paging message to the MS 100 at step 3d. It is checked at step 3e whether a paging response message has been received from the MS 100. If a paging response message has been received from the MS 100, it is transmitted to the pBTMR 540 through the pBAN 550 at step 3f. The pBTMR 540 transmits the paging response message to the BSC 300 for the public network through the pBAN 550 at step 3g. Then, the BSC 300 performs a call process at step 3h.

On the other hand, if a paging response message has not been received from the MS 100, it is checked whether the number of transmission times is greater than a predetermined number of transmission times, e.g., 2. If the number of re-transmission times is greater than a predetermined number of transmission times, the BSC 300 proceeds to step 3j in order to terminate paging service. Otherwise, the paging message is re-transmitted at the above step 3a.

In the case where the MS 100 has a problem or currently uses the private network, the MS 100 cannot transmit the paging response message. The latter case means that the MS 100 communicates with another subscriber terminal 700 located in the local area of the private network. Accordingly, although a paging signal (incoming call signal) is generated from the public network, the MS 100 cannot transmit any response message because of being in the busy state. At this time, because the public network recognizes that the MS 100 is in the idle state rather than the busy state, the wireless public network continuously transmits the paging signal (incoming call signal) toward the MS 100. As described above, the paging message can be transmitted twice. If the MS 100 is in the busy state while the paging message is transmitted twice, the BSC cannot help performing a non-response process because the MS 100 cannot give any response to the paging signal (incoming call signal). In this case, because the public network cannot identify the location of the MS 100 and transmits the paging signal twice, radio resources of the public network cannot be effectively managed.

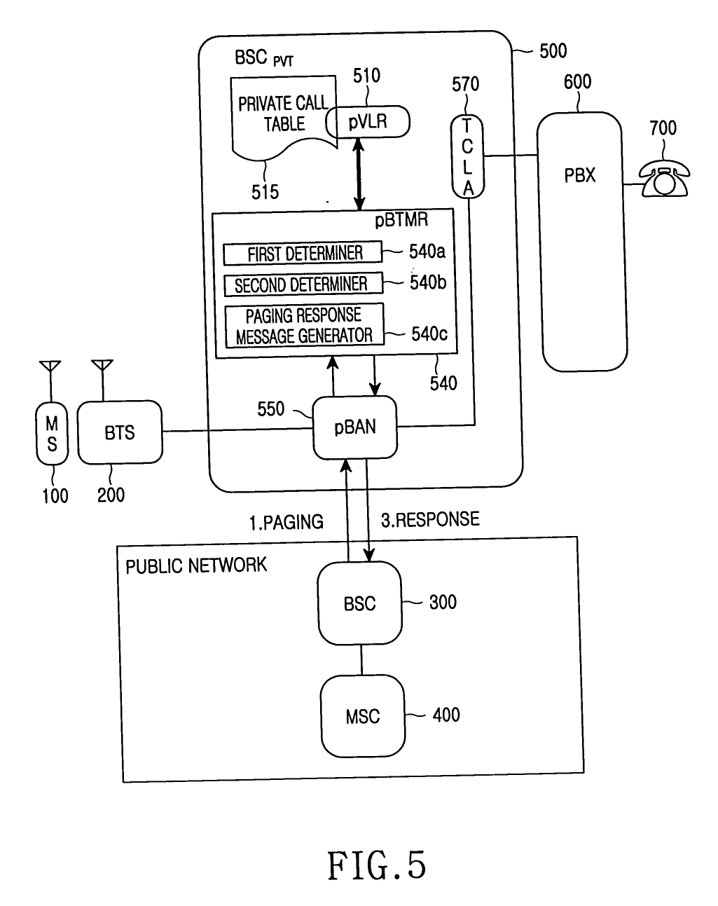

FIG. 5 is another exemplary view illustrating a configuration of a public and private communication service apparatus associated with a public and private mobile communication system in accordance with the present invention.

An embodiment shown in FIG. 5 can be implemented in the public and private communication service apparatus shown in FIG. 3. The pMSC 520, the pBSC 530 and the PMIC 560 shown in FIG. 3 are omitted in the embodiment shown in FIG. 5.

In accordance with the embodiment of the present invention, a pBTMR 540 of the public and private communication service apparatus includes first and second determiners 540a and 540b and a paging response message generator 540c. The first determiner 540a determines whether a call directed from the public network to the MS 100 is generated. The second determiner 540b determines whether the MS 100 is in a local-area call connection state. If a call directed from the public network to the MS 100 is generated and the MS 100 is in the local-area call connection state, the paging response message generator 540c generates a paging response message to transmit it to the public network instead of the MS 100.

The second determiner 540b can determine whether the MS 100 is connected to the private network or in the local-area call connection state, by retrieving a private call table 515 having state information of the MS 100.

A description will be given of processes of transmitting paging call signals from the public and private networks and processes of generating paging response messages in response to the paging call signals.

The process of transmitting the paging call signal from the public network is based on a path of “MSC→BSC→BSC_{PVT}(pBTMR)→BTS→MS”. The process of generating the paging response message is based on a path of “MS→BTS→BSC_{PVT}(pBTMR)→BSC→MSC”. Here, the BSC_{PVT}(pBTMR) represents a software module for routing a message from the BTS 200.

The process of transmitting the paging call signal from the private network is based on a path of “pMSC→BSC_{PVT}(pBTMR)→BTS→MS”. The process of generating the paging response message is based on a path of “MS→BTS→BSC_{PVT}(pBTMR)→pMSC”.

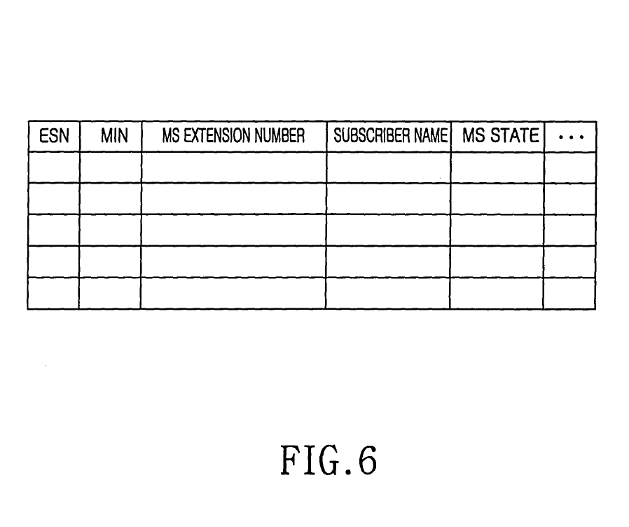

FIG. 6 is a view illustrating a structure of a table having state information of MSs included in a visitor location register for a private network in accordance with the present invention.

The private call table includes an ESN (Electronic Serial Number) of each MS, an MIN (Mobile Identification Number), an extension number, a subscriber name, state information. The state information indicates whether the MS uses the private network. The state information is recorded or deleted by the pMSC 520. When the MS receives a paging call signal from the private network, the state information indicating that the MS currently uses the private network is recorded. When the call signal is released, the recorded state information is deleted.

When the paging response message is generated in response to the paging call signal, the pBTMR 540 retrieves the state information and then routes the paging response message. Further, the pBTMR 540 retrieves the state information and performs routing in response to the paging call signal from the public network. In other words, if a corresponding terminal uses the private network, the pBTMR 540 generates the paging response message instead of the terminal and then transmits it to the public network.

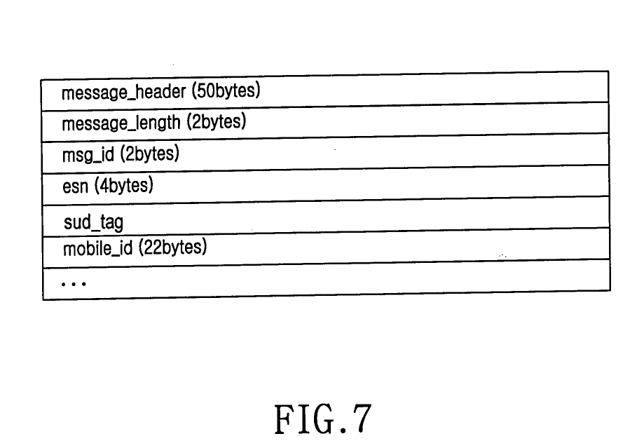

FIG. 7 is a view illustrating a format of a paging response message in accordance with the present invention.

As shown in FIG. 7, a message tag “sud_tag” indicates a type of a message such as a PRM (Paging Response Message) or an RGM (Registration Message). A mobile identification “mobile_id” includes an ESN, an MIN and an IMSI (International Mobile Subscriber Identity), etc. The IMSI is stored in an SIM (Subscriber Identity Module) and used in authentication for system connection.

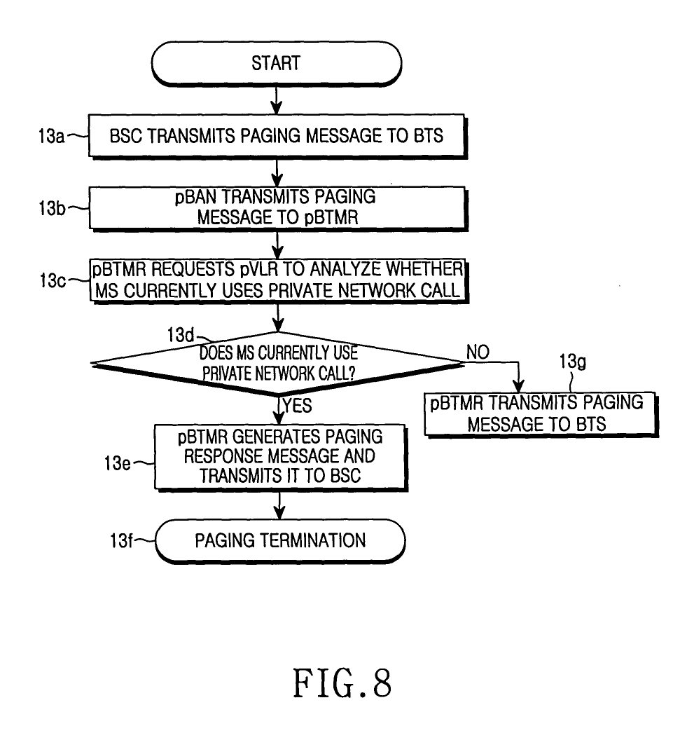

FIG. 8 is a flow chart illustrating a method for allowing a private network to process a paging call signal from a public network in accordance with the present invention. The call process performed by the private network is made up of four stages. The method will be described with reference to FIGS. 5 and 8.

A first stage: It is determined whether the public network generates the paging call signal directed to the MS 100.

The BSC 300 transmits a paging message to the BTS 200 in order to page the MS 100 located in a public and private cell area at step 13a.

A second stage: If the public network generates the paging call signal directed to the MS 100 at the first stage, it is checked on the basis of the private call table 515 shown in FIG. 6 whether the MS 100 currently uses the private network.

The pBAN 550 transmits the paging message to the pBTMR 540 at step 13b. The pBTMR 540 requests the pVLR 510 to analyze whether the MS 100 currently uses a private network call at step 13c.

A third stage: If the MS 100 currently uses a private network call at the second stage, the pBTMR 540 generates a paging response message instead of the MS 100 as shown in FIG. 7 and then transmits it to the public network.

If the MS 100 currently uses the private network call at step 13d, the pBTMR 540 generates the paging response message instead of the MS 100 as shown in FIG. 7 and then transmits it to the BSC 300 of the public network through the pBAN 550 at step 13e. The BSC 300 terminates the paging service at step 13f.

A fourth stage: If the MS 100 does not currently use the private network call at the second stage, a following step is performed. In other words, if the MS 100 does not currently use the private network call at step 13d, the pBTMR 540 transmits the paging message to the BTS 200 through the pBAN 550 at step 3g.

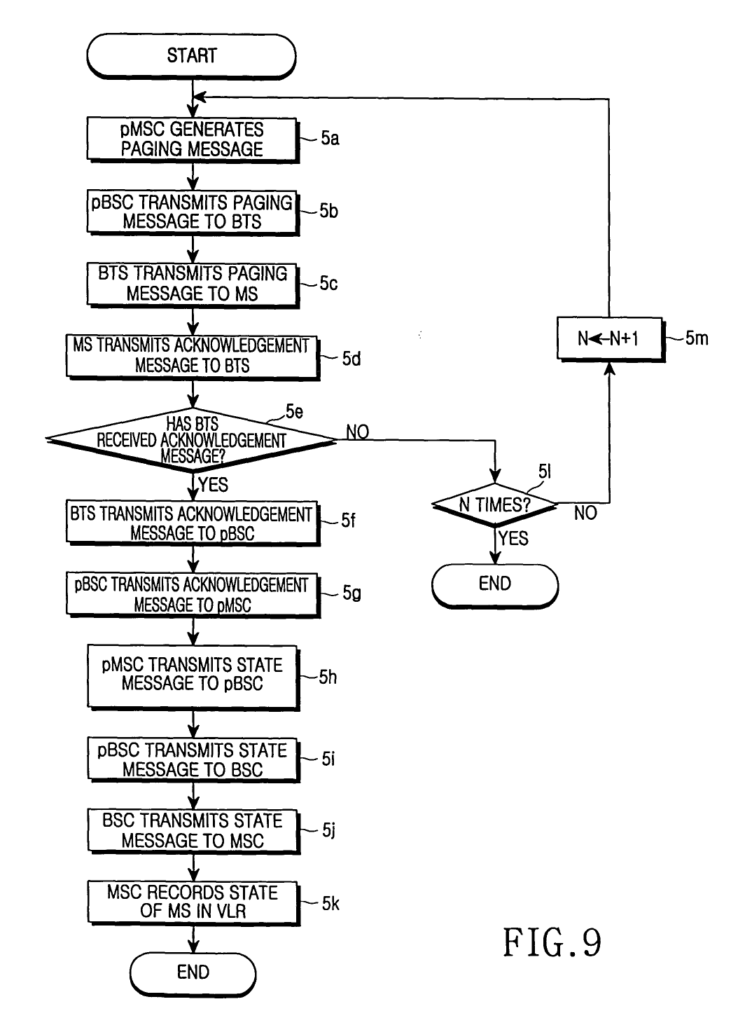

FIG. 9 is a flow chart illustrating a method for allowing a private network to transmit state information of a local-area MS located within a public and private cell area to the public network in accordance with the present invention.

In FIG. 3, the process of transmitting the paging call signal from the private network is based on a path of “pMSC→BSC_{PVT}(pBTMR)→BTS→MS”. The process of generating the paging response message is based on a path of “MS→BTS→BSC_{PVT}(pBTMR)→pMSC”. Further, the process of transmitting the state information of the local-area MS in the private network is based on a path of “BSC_{PVT}(pBTMR)→BSC→MSC”. The above-described processes will be described in detail with reference to FIG. 9.

It is assumed that the MS 100 is paged from another subscriber terminal 700 in the local area. The state information of the MS 100 is transmitted to the public network. This process is as follows.

A first stage: If the PBX transmits a paging request message in order to page the MS 100 located in a public and private cell area, the pMSC 520 generates a paging message at step 5a. The pBSC 530 transmits the paging message to the BTS 200 at step 5b. The BTS 200 transmits the paging message to the MS 100 at step 5c.

A second stage: In response to the paging message, the MS 100 generates an acknowledgement message and then transmits it to the BTS 200 at step 5d.

A third stage: The BTS 200 transmits the acknowledgement message to the pBSC 530 through the pBAN 550 at steps 5e and 5f. The pBSC 530 transmits the acknowledgement message to the pMSC 520 at step 5g. The pMSC 520 forms a communication path in response to the acknowledgement message and then transmits a state message indicating a state (e.g., busy state) of the MS 100 to the pBSC 530 at step 5h. The pBSC 530 transmits the state message to the BSC 300 for the public network through the pBAN 550 at step 5i. The BSC 300 transmits the state message to the MSC 400 at step 5j. The MSC 400 records the state (e.g., busy state) of the MS 100 in the VLR in response to the state message at step 5k.

A fourth stage: If the acknowledgement message has not been received at the third stage, a step relating to non-response is performed. In other words, if the pMSC 520 has not received the acknowledgement message at step 5e, the paging message is re-transmitted the predetermined number of times (or for a predetermined period of time) on the basis of steps 5l and 5m.

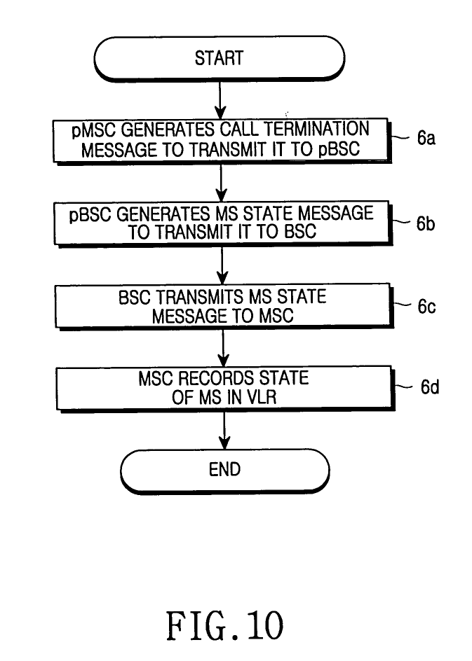

FIG. 10 is a flow chart illustrating a method for transmitting an MS state message to an MSC when the private network terminates an MS call in accordance with the present invention.

A first stage: The pMSC 520 generates a call termination message relating to the MS 100 located in a public and private cell area at step 6a.

A second stage: In response to the call termination message, the pBSC 530 generates an MS state (e.g., idle state) message and then transmits it to the BSC 300 for the public network through the pBAN 550 at step 6b.

A third stage: The BSC 300 transmits the MS state message to the MSC 400 at step 6c and then the MSC 400 records the state (e.g., idle state) of the MS 100 in the VLR in response to the MS state message at step 6d.

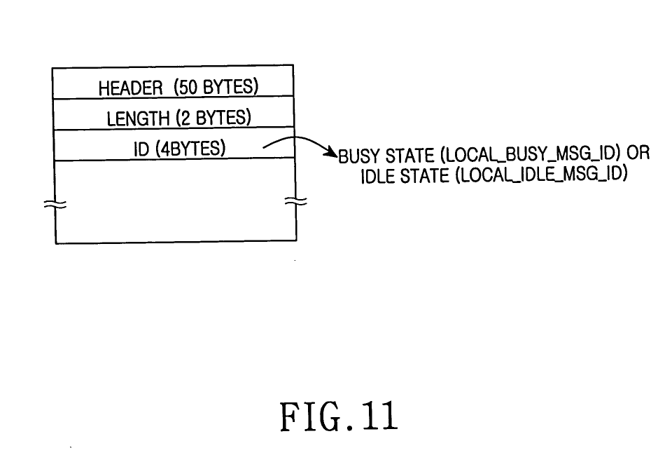

FIG. 11 is a view illustrating a format of a new message, which is made for matching subscriber states, in accordance with the present invention.

The new message includes message fields. The message fields basically contain a 50-byte message header field, a 2-byte message length field and a 4-byte message ID (identification) field. Destination and source addresses are recorded in the message header field. A length of a message is recorded in the message length field. A type of a message is recorded in the message ID field.

The busy state “LOCAL_BUSY_MSG_TYPE” or the idle state “LOCAL_IDLE_MSG_TYPE” can be recorded in the message ID field so that the message is used for matching the subscriber states.

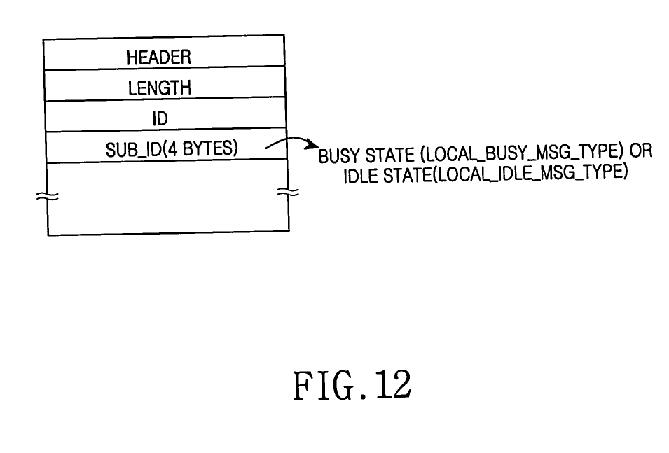

FIG. 12 is a view illustrating a message in which sub-ID and sub-type data are added to a pre-existing message for matching subscriber states in accordance with the present invention.

As compared with the message shown in FIG. 11, the message shown in FIG. 12 further includes a message sub-ID field. The message sub-ID field is of 4 bytes. The sub-type of the message is recorded in the message sub-ID field.

The busy state “LOCAL_BUSY_MSG_TYPE” or the idle state “LOCAL_IDLE_MSG_TYPE” can be recorded in the message sub-ID field so that the message is used for matching the subscriber states.

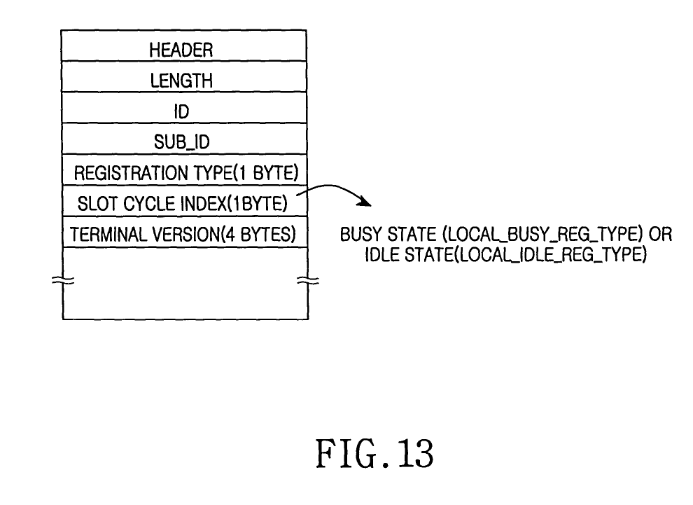

FIG. 13 is a view illustrating a message in which sub-ID and sub-type data are added to a location registration message for matching subscriber states in accordance with the present invention.

As compared with messages shown in FIGS. 11 and 12, the location registration message shown in FIG. 13 further includes a 1-byte registration type field, a 1-byte slot cycle index field and a terminal version field.

The busy state “LOCAL_BUSY_MSG_TYPE” or the idle state “LOCAL_IDLE_MSG_TYPE” can be recorded in the registration type field so that the location registration message is used for matching the subscriber states. Further, a slot cycle index is provided for indicating a cycle so that the terminal can search a paging channel message for the cycle. For example, a slot cycle index “0” indicates a cycle of 1.28 seconds. A slot cycle index “1” indicates a cycle of 2.56 seconds. A slot cycle index “2” indicates a cycle of 5.12 seconds. Terminal versions “1”, “2” and “3” are IS-95, IS-95-A (Telecommunication Industry Association (TIA)/Electronic Industry Alliance (EIA) IS-95 and IS-95A) and TSB 44, respectively.

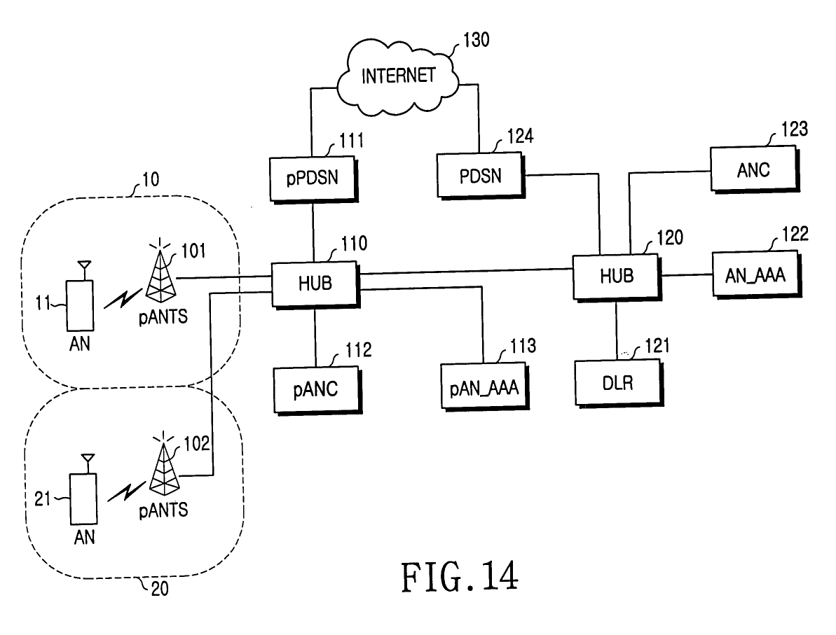

FIG. 14 is a view illustrating a configuration of a public/private mobile communication network where the present invention is applied to a high-speed wireless data system for 1× EV-DO (1× Evolution-Data Only) ANs (Access Nodes). The mobile communication network is a wireless network capable of using a public network or PLMN (Public Land Mobile Network) and a private network. Hereinafter, functions and operations associated with a network configuration and a network element configuration for the high-speed wireless data system will be described with reference to FIG. 14. The prefix “p” is attached to nodes for a private network and nodes commonly used by the wireless private network and the PLMN in FIG. 14 as in FIG. 1.

ANs 11 and 21 shown in FIG. 14 are terminals conventionally used for the high-speed wireless data system. Here, we assume that the AN 11 is a subscriber capable of receiving a wireless private network service, and the AN 21 is a subscriber for receiving a PLMN service. Furthermore, pANTSs (private Access Network Transceiver Systems) 101 and 102 shown in FIG. 14 have wireless service areas 10 and 20, respectively. The pANTS 101 or 102 sets up a session when the AN 11 or 21 moves to within the wireless service area 10 or 20 and performs a necessary operation when a UATI (Unicast Access Terminal Identifier) is assigned to a corresponding AN 11 or 21. When incoming call reception for the AN 11 or 21 is made or outgoing call transmission for the AN 11 or 21 is made, a corresponding operation is performed. The pANTSs 101 and 102 are coupled to a hub 110.

The hub 110 is coupled to nodes within the wireless private network and the PLMN or another hub which allows the hub 110 to be coupled to other nodes. The hub 110 is coupled to a hub 120 when the hub 110 is coupled to a node outside the wireless private network as shown in FIG. 14. The hub 110 is coupled to a pPDSN (private Packet Data Serving Node) 111 that only ANs within the wireless private network can use. The hub 110 is coupled to a pANC 112 commonly used by the wireless private network and the PLMN and a pAN_AAA (private Access Network-Authentication Accounting Authorization) system 113 used only in the wireless private network to carry out a data relay operation. The pAN_AAA 113 can be configured so that it can be commonly used in the wireless private network and the PLMN.

The pANC 112 for the wireless private network sets up a session associated with the AN 11 or 21, assigns a UATI to the AN 11 or 21 and performs a control operation when an AN authentication procedure is performed by the pAN_AAA system 113. The pANC 112 carries out a routing operation for a service to the AN 11 or 21 within the wireless private network or the pPDSN 111 and carries out a routing operation for a service to a network external to the private network. Furthermore, the pANC 112 performs a session setup and update operation necessary for authenticating the AN 11 or 21, a control operation necessary for assigning a UATI to the AN 11 or 21, a traffic control operation based on a call setup, various signalling control operations, etc. For example, the pANC 112 transfers a paging signal to the AN 11 or 21 or carries out a session information assignment or update operation, a location information storage operation and a UATI assignment operation for a DLR (Data Location Register) 121.

The hub 120 is coupled to an AN_AAA 122, an ANC 123, a PDSN 124 and the DLR 121, and performs a data relay operation between nodes. Furthermore, the hub 120 can be coupled to an ANTS for the PLMN, but the ANTS for the PLMN coupled to the hub 120 is not shown in FIG. 14.

The PDSN 124 can be coupled to other PDSNs over the Internet 130 or can be coupled to the pPDSN 111. The ANC 123 for the public network is a general ANC for the high-speed wireless is data system, and the AN_AAA 122 is a general AN_AAA for the high-speed wireless data system.

The DLR 121 stores AN information and AN location information associated with the high-speed wireless data system and provides AN information when a session associated with a corresponding AN is updated. Furthermore, the DLR 121 stores AN information associated with the PLMN, and the AN information associated with the PLMN includes AN state information, user information, service class information, etc. The DLR 121 further includes AN information associated with the wireless private network in accordance with the present invention. The information registered in the DLR 121 is classified into information associated with the case where a corresponding AN receives a service from only the wireless private network and information associated with the case where a corresponding AN receives services from both the wireless private network and the PLMN. The present invention is described in terms of the case where the corresponding AN receives services from both the wireless private network and the PLMN. In this case, the DLR 121 stores the information associated with the AN of the wireless private network equal to the information associated with the AN of the PLMN, and further stores information associated with the wireless private network. Here, the information associated with the wireless private network includes information associated with a service area, e.g., an ANTS or sector, service time information, service type information, etc. Furthermore, the DLR 121 can be configured so that it can carry out an assignment operation according to a special agreement when a UATI is assigned to a corresponding AN.

Where the AN for the wireless private network receives a service, an identifier for discriminating a connection to the wireless private network and a connection to the public network is further provided and transmitted.

The pANTSs 101 and 102, the pANC 112, the ANC 123, the DLR 121,the pPDSN 111 and the PDSN 124 can be configured so that they are based on an IP (Internet protocol). Conventionally, connections between the pANTSs 101, the ANC 112 and the ANC 123, and connections between the DLR 121, the pPDSN 111 and the PDSN 124 are configured on the basis of an ATM (Asynchronous Transfer Mode). The conventional ATM-based configuration cannot implement cost-effective communication, while the IP-based configuration can implement cost effective communication. Where the pANTSs 101 and 102, the pANC 112, the ANC 123, the DLR 121, the pPDSN 111 and the PDSN 124 are configured on the basis of the IP, communications between internal boards or processors are configured so that the communications can be performed according to IPC (Inter Process Communication). Internal processors or boards of respective nodes are assigned specific IP addresses. Where the above-described nodes are located within a predetermined CO (Central Office), the nodes are assigned internal IP addresses. Nodes located outside the CO are assigned fixed IP addresses. Thus, a sufficient number of IP addresses can be assigned to the nodes.

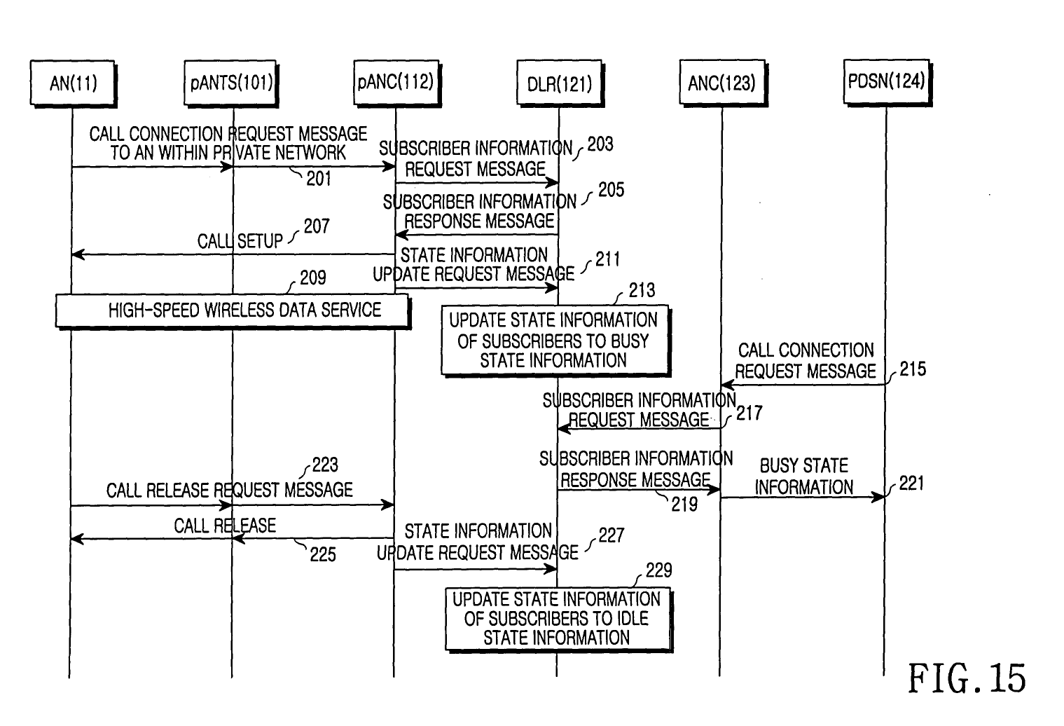

Interfaces between the pANTSs 101 and 102 and the pANC 112 and the ANC 123 can use an ADSL (Asymmetric Digital Subscriber Line) modem or cable modem, etc. Furthermore, there is no problem because the pAN_AAA 113, the AN_AAA 122, the ANC 123 and the PDSN 124 can be initially configured on the basis of the IP. Message flow according to a call transmission process for communication within the wireless private network for the high-speed wireless data communication system in accordance with the embodiment of the present invention will be described with reference to FIG. 2. FIG. 15 is a flow chart illustrating a call processing procedure for managing state information of ANs shown in FIG. 14.

Referring to FIG. 15, the AN 11 of the wireless private network sends, to the pANTS 101, a call connection request message containing a UATI and a destination address according to an air interface protocol when making a 1× EV-DO service request at step 201. In accordance with the present invention, the AN 11 sends the call connection request message associated with a terminating AN coupled to the private network. Upon receiving the call connection request message, the pANTS 101 transfers the call connection request message to the hub 110 after an IP (Internet protocol) communication process. The hub 110 transfers a received call connection request message to the pANC 112. The pANC 112 for the private network sends, to the DLR 121, a request message indicating that information associated with a subscriber of the terminating AN must be provided at step 203. Upon receiving the subscriber information request message, the DLR 121 queries corresponding subscriber information and sends a subscriber information response message containing the subscriber information to the pANC 112 at step 205. The pANC 112 identifies a location of the terminating AN within the private network using the subscriber information contained in the received subscriber information response message and sets up a call at step 207. Thus, the AN 11 of the wireless private network receives a high-speed wireless data service at step 209. As described above, where the terminating AN is located within the private network, AN state information being subscriber information of the DLR 121 is not conventionally updated after the call setup. However, the AN state information is updated in accordance with the present invention.

After the above step 207, the pANC 112 sends a state information update request message containing current state information of the originating AN 11 and the terminating AN to the DLR 121 at step 211. In other words, the pANC 112 sends a request message indicating that the state information of the originating AN 11 and the terminating AN must be updated to busy state information. The DLR 121 searches for the subscriber information upon receiving the state information update request message and updates AN state information to busy state information at step 213.

Then, upon receiving a call connection request message indicating that an arbitrary AN has made a request for a call connection with one of the ANs receiving the high-speed wireless data service, the PDSN 124 sends the ANC 123 for the public network at step 215. It is assumed that the AN making the call connection request through the PDSN 124 requests that it be connected to the AN 11 in accordance with the embodiment of the present invention. Similarly, the above-described procedure is equally performed when the AN 11 makes a call connection request. The ANC 123 for the public network sends a subscriber information request message indicating that the DLR 121 must provide the subscriber information of the AN 11 at step 217. Upon receiving the subscriber information response message, the DLR 121 searches for the subscriber information of the AN 11 and sends a subscriber information response message containing the subscriber information to the ANC 123 at step 219. Upon receiving the subscriber information response message, the ANC 123 analyzes the subscriber information and identifies that the state of the AN 11 is a busy state. The ANC 123 sends, to the PDSN 124, a message indicating that the AN 11 is in the busy state at step 221.

If the high-speed wireless data communication service is completed, the AN 11 sends a call release request message to the pANC 112 for the wireless private network through the pANTS 101 at step 223. In response to the call release request message, the pANC 112 releases the call associated with the AN 11 at step 225, and the following step 227 is performed. At the above step 227, the pANC 112 sends, to the DLR 121, a subscriber state information message indicating that the AN 11 is in an idle state. In response to the subscriber state information message, the DLR 121 updates the state information of the AN 11 to the idle state at step 229.

Also when the communication is performed between ANs within the wireless private network, the pANC 112 allows the DLR 121 to update the subscriber information according to states of the ANs.

The present invention can be realized as computer-executable instructions in computer_readable media. The computer_readable media includes all possible kinds of media in which computer_readable data is stored or included or can include any type of data that can be read by a computer or a processing unit. The computer_readable media include for example and not limited to storing media, such as magnetic storing media (e.g., ROMs, floppy disks, hard disk, and the like), optical reading media (e.g., CD_ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer_readable media can store and execute computer_readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

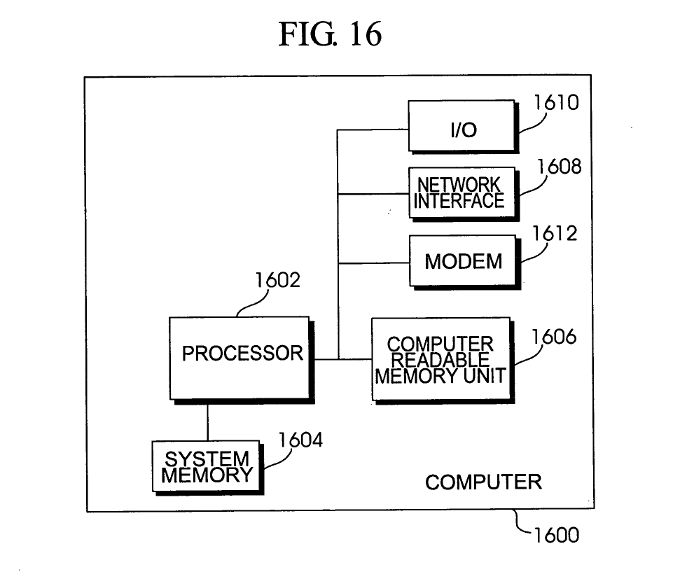

An example of a computer, but not limited to this example of the computer, that can read computer readable media that includes computer-executable instructions of the present invention is shown in FIG. 16. The computer 1600 includes a processor 1602 that controls the computer 1600. The processor 1602 uses the system memory 1604 and a computer readable memory device 1606 that includes certain computer readable recording media. A system bus connects the processor 1602 to a network interface 1608, modem 1612 or other interface that accommodates a connection to another computer or network such as the Internet. The system bus may also include an input and output interface 1610 that accommodates connection to a variety of other devices.

As apparent from the above description, the present invention provides an apparatus, method and system, which can allow a public network to recognize state information of a private network subscriber located in a private and public cell area by transmitting terminal state information from the private network to the public network in a mobile communication system interworked with the public and private networks. Accordingly, public and private mobile communication services can be quickly and smoothly provided. Further, the present invention can efficiently manage radio resources by removing unnecessary paging, e.g., transmission of a second paging call signal, or an error process based on a paging non-response.

Although the preferred embodiments of the present invention have been disclosed for illustrative purposes, they are not intended to limit the scope of the present invention. Those skilled in the art will appreciate that various modifications, additions and substitutions are possible, without departing from the scope of the invention. Therefore, the present invention is not limited to the above-described embodiments, but the present invention is defined by the claims which follow, along with their full scope of equivalents.

What is claimed is:

1. A method for performing a call processing operation to manage state information of access nodes in a high-speed wireless data system, comprising the steps of:
when an access node coupled to a wireless private network makes a request for a call connection with another access node coupled to the wireless private network, carrying out a call connection between the access nodes, providing a high-speed wireless data service for the access nodes, and carrying out a call connection release after completing the high-speed wireless data service; and
updating state information of the access nodes according to the call connection and connection release between the access nodes.

2. A method for performing a call processing operation to manage state information of access nodes in a high-speed wireless data system, comprising the steps of:
when an access node coupled to a wireless private network makes a request for a call connection with another access node coupled to the wireless private network, carrying out a call connection between the access nodes and providing a high-speed wireless data service for the access nodes;
updating state information of the access nodes to busy state information;
when the high-speed wireless data service for the access nodes is completed, carrying out a call connection release; and
updating the state information of the access nodes to idle state information according to the call connection release.

3. A method for performing a call processing operation to manage state information of access nodes in a high-speed wireless data system, comprising the steps of:
when an access node coupled to a wireless private network makes a request for a call connection with another access node coupled to the wireless private network, allowing a private access network controller to carry out a call connection between the access nodes and to provide a high-speed wireless data service for the access nodes;
allowing the private access network controller to request that state information of the access nodes be updated;
allowing a data location register to update the state information of the access nodes to busy state information according to a state information update request;
when the high-speed wireless data service for the access nodes is completed, carrying out a call connection release between the access nodes and allowing the private access network controller to request that the state information of the access nodes be updated; and
allowing the data location register to update the state information of the access nodes to idle state information according to another state information update request.

4. The method of claim 3, with the data location register storing the information associated with the access node requesting for the call connection being equal to the information associated with the other access node.

5. The method of claim 4, with the private access network controller and the data location register being configured to being based on an Internet protocol.

6. The method of claim 5, with the private access network controller sending a state information update request message including current state information of the originating access node and the terminating access node to the data location register.

7. The method of claim 5, with the private access network controller sending a request message indicating the state information of the originating access node and the terminating access node to be updated to busy state information and the data location register searching for the subscriber information upon receiving the state information update request and updating the access node state information to busy state information.

8. A wireless data system, comprising:
a first access node receiving a first network service;
a second access node receiving a second network service;
a first private access network transceiver system setting up a session when the first access node moves within the wireless service area of the first private access network transceiver;
a second private access network transceiver system setting up a session when the second access node moves within the wireless service area of the second private access network transceiver; and
a private access network controller carrying out a call connection between the access nodes and to provide data service for the first and second access nodes when the first access node makes a request for a call connection with the second access node coupled to the first network service and the private access network controller requesting the state information of the first and second access nodes to be updated.

9. The system of claim 8, further comprising a data location register updating the state information of the access nodes to busy state information according to a state information update request.

10. The system of claim 9, with the private access network controller requesting that the state information of the access nodes be updated and carrying out a call connection release between the access nodes when the data service for the access nodes is completed.

11. The system of claim 10, with the data location register updating the state information of the access nodes to idle state information according to another state information update request.

12. The system of claim 11, with the first network service being a wireless private network.

13. The system of claim 12, with the second network service being a public land mobile network.

14. The system of claim 12, with the second network service being a public network.

15. The system of claim 13, with the data location register storing the information associated with the first access node of the wireless private network equal to the information associated with the second access node of the public land mobile network.

16. The system of claim 15, with the private access network controller and the data location register being configured to being based on an Internet protocol.

17. The system of claim 16, with the private access network controller sending a request message indicating the state information of the originating access node and the terminating access node to be updated to busy state information and the data location register searching for the subscriber information upon receiving the state information update request and updating the access node state information to busy state information.

18. A computer-readable medium having computer-executable instructions for performing a method for performing a call processing operation to manage state information of access nodes in a high-speed wireless data system, comprising:
when an access node coupled to a wireless private network makes a request for a call connection with another access node coupled to the wireless private network, carrying out a call connection between the access nodes, providing a high-speed wireless data service for the access nodes, and carrying out a call connection release after completing the high-speed wireless data service; and
updating state information of the access nodes according to the call connection and connection release between the access nodes.

19. A computer-readable medium having computer-executable instructions for performing a method for performing a call processing operation to manage state information of access nodes in a high-speed wireless data system, comprising:
when an access node coupled to a wireless private network makes a request for a call connection with another access node coupled to the wireless private network, carrying out a call connection between the access nodes and providing a high-speed wireless data service for the access nodes;
updating state information of the access nodes to busy state information;
when the high-speed wireless data service for the access nodes is completed, carrying out a call connection release; and
updating the state information of the access nodes to idle state information according to the call connection release.

20. A computer-readable medium having stored thereon a data structure for performing a call processing operation to manage state information of access nodes in a high-speed wireless data system, comprising:
a first field containing data representing when an access node coupled to a wireless private network makes a request for a call connection with another access node coupled to the wireless private network, allowing a private access network controller to carry out a call connection between the access nodes and to provide a high-speed wireless data service for the access nodes;
a second field containing data representing allowing the private access network controller to request that state information of the access nodes be updated;
a third field containing data representing allowing a data location register to update the state information of the access nodes to busy state information according to a state information update request;
a fourth field containing data representing when the high-speed wireless data service for the access nodes is completed, carrying out a call connection release between the access nodes and allowing the private access network controller to request that the state information of the access nodes be updated; and
a fifth field containing data representing allowing the data location register to update the state information of the access nodes to idle state information according to another state information update request.
